(19) United States
(12) Patent Application Publication
(10) Pub. No.: US 2007/0121347 A1
(43) Pub. Date: May 31, 2007

(54) Securing apparatus for night light chamber cover

(75) Inventor: Chou Shih Bin, Taipei (TW)

Correspondence Address: ZITO TLP, P.O. BOX 240, DAMASCUS, MD, 20872, US

(73) Assignee: Canel Lighting Co., Ltd.

(21) Appl. No.: 11/290,862

(22) Filed: Nov. 30, 2005

(51) Int. Cl. H01R 33/00

(52) U.S. Cl. 362/655

(57) ABSTRACT

A securing apparatus for holding chamber covers onto a chamber base of a lamp is disclosed. The chamber may provide access to a night light bulb held in place by a clip passing through the bottom of said chamber. The securing apparatus comprises a locking sleeve with an integral check-ring designed to engage a threaded coupling mounted on a neck tube of the lamp. The locking sleeve is designed with a threaded lower end, which when engaged with the threaded coupling forces the bottom of the check-ring to engage the top of the cover when the cover is in place on the chamber base. Only the length of the locking sleeve needs to be changed to accommodate various depths of chamber covers, providing an economical way to adjust the general aesthetics of the lamp by varying only the look of the cover.

### FIELD OF THE INVENTION

The present invention relates to the field of lamps with integrated night lights. More specifically, the present invention is a variable locking sleeve with integral check-ring engaging a threaded coupling for holding varying-depth chamber covers on a single general design of a lamp.

### BACKGROUND OF THE INVENTION

There are several types of lamps with night lights wherein the night light is integrated into body of the lamp. In such lamps, the electrical circuitry permits first the lighting of the night light by itself, then the lighting of the main light by itself, both lights at the same time and then finally, the lighting of neither light. The main light bulb is easily accessible via a conventional light bulb socket located at the top of the lamp body, generally inside and under a shade, also attached to the top of the lamp. The night light socket however, is generally concealed within the body of the lamp base.

In a prior art example, as shown in FIG. 1, a lamp 100 comprises a lamp base 101, a neck tube 102 attached to the top of a connecting apparatus 103 between the base and the tube, a socket 104 and a chamber cover 105. The chamber cover sits atop a chamber base 106, which together with said chamber cover in place collectively comprise a night light socket access chamber. A night light socket 107 with a night light bulb is installed into base 101 through a hole in the bottom of said chamber base and is held in place by a spring clip 108 which engages the edges of said hole. With the night light socket installed and the chamber cover lowered to seat on top of the chamber base, the night light bulb, socket and spring clip are hidden from view.

To hold the chamber cover in place, a locking ring 109 is slid downward along the neck tube and is threaded onto a set of threads 110 located at the bottom of the neck tube. The location of the threads on the neck tube coincides with the top of the chamber cover when the chamber cover is seated on the chamber base. As locking ring 109 is threaded onto threads 110, the bottom of the locking ring impinges on the top of the chamber cover, thus holding it in place.

This arrangement, while suitable for certain implementations, limits efficient variability in the design. That is, for a given design configuration of lamp base, neck tube, connecting apparatus and socket, where the overall height of the lamp is to be maintained, the options for the chamber cover are limited. Specifically, for the given design as noted above, the depth of the chamber cover must remained fixed. Any change in the design depth of the chamber cover would necessitate a new design of either the depth of the lamp base, the neck tube or the interconnecting structure.

This can be an unsuitable situation where various depths of chamber covers might be desired for a given lamp design to provide variety of style without undue cost to the manufacture of the lamp.

### SUMMARY OF THE INVENTION

A securing apparatus for holding a chamber cover onto a chamber base of a lamp is disclosed. The securing apparatus provides a simple and economical means for varying the depth of the cover associated with a specific lamp design without having to alter the remaining elements of the lamp. The invention thus affords a wide range of variation in the style of the cover for a given lamp.

In an exemplary embodiment, the securing apparatus comprises a locking sleeve with an integral check-ring designed to engage a threaded coupling mounted on the base of the neck tube. The locking sleeve is designed with a threaded lower end, which when engaged with the threaded coupling forces the bottom of the check-ring to engage the top of the cover when the cover is in place on the chamber base.

The length of the inventive locking sleeve may be varied to accommodate various depths of chamber covers. Varying only the depth of the locking sleeve to accommodate different covers without having to change other lamp elements to do so provides a less complex and less costly way to vary the design aspects of the cover, and by extension, the design of the overall lamp, than is permitted by the cited prior art.

### BRIEF DESCRIPTION OF THE DRAWINGS

Exemplary embodiments of the invention are discussed hereinafter in reference to the drawings, in which:

FIG. 1 is a section view through a lamp of the prior art indicating chamber cover 105, locking ring 109 and threaded end 110. When the cover is lowered and the locking ring is threaded onto the threaded end, the locking ring holds the cover in place.

FIG. 2 is a section view through the lamp of the present invention indicating chamber cover 205, locking sleeve with integral check-ring 209 and threaded coupling 210. When the cover is lowered and the locking sleeve is threaded onto the threaded coupling, the check-ring on the locking sleeve holds the cover in place.

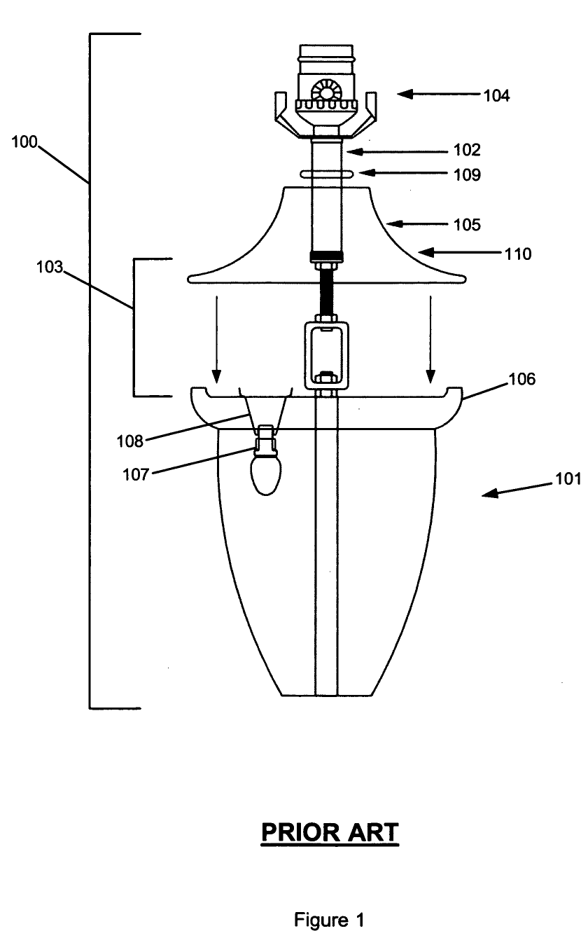

### DETAILED DESCRIPTION OF PREFERRED EXEMPLARY EMBODIMENTS

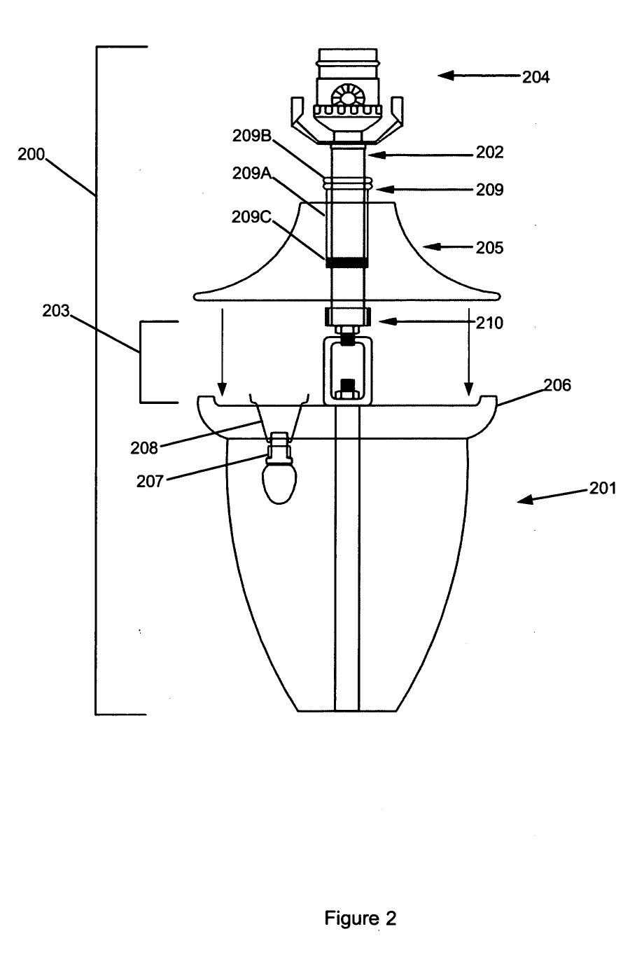

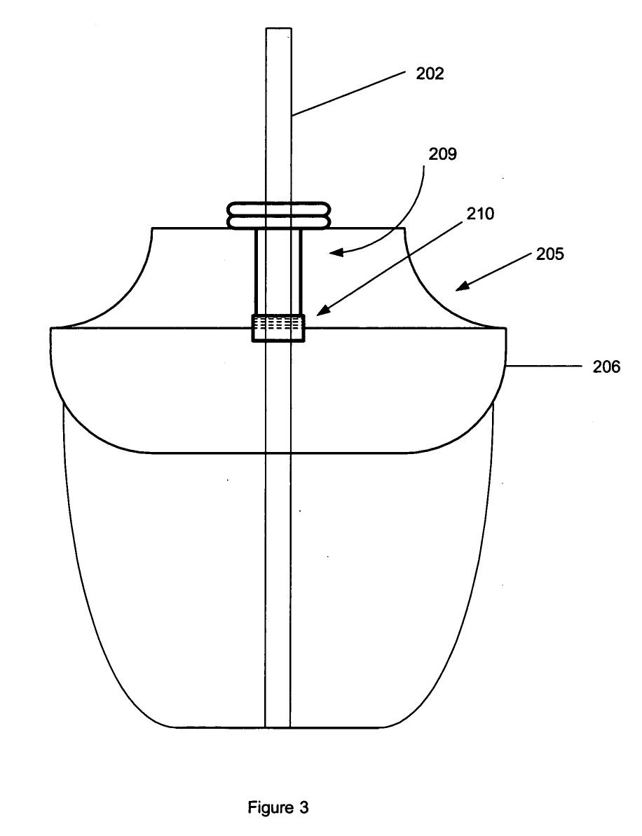

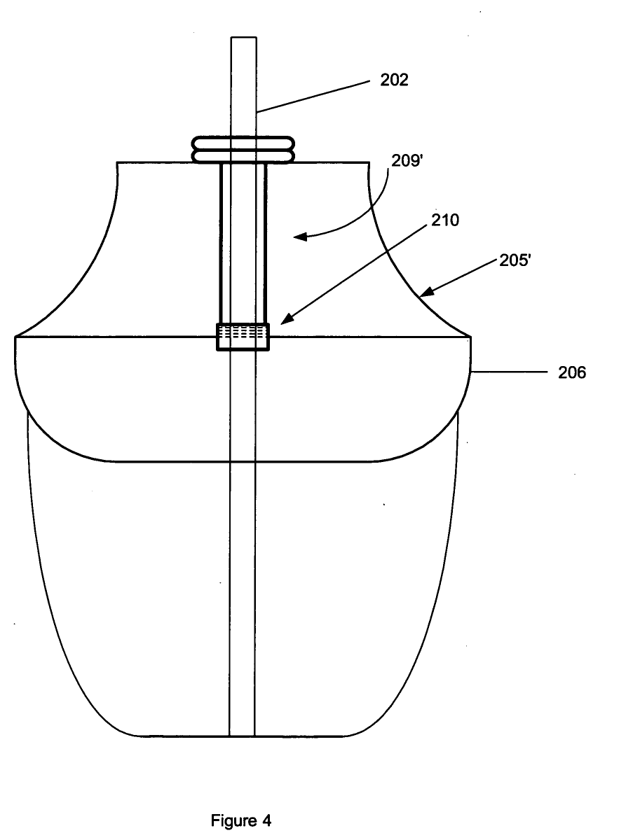

The securing apparatus of the present invention, shown employed on an exemplary lamp 200 in FIG. 2, comprises a locking sleeve 209 which is threaded into a threaded coupling 210 mounted on the base of neck tube 202. In the exemplary embodiment, lamp 200 comprises a lamp base 201, a neck tube 202 attached to the top of a connecting apparatus 203 between the base and the tube, a socket 204 and a chamber cover 205. The chamber cover sits atop a chamber base 206, which together with said chamber cover in place collectively comprise a night light socket access chamber.

A night light socket 207 with a night light bulb is installed into base 201 through a hole in the bottom of said chamber base and is held in place by a spring clip 208 which engages the edges of said hole. With the night light socket installed and the chamber cover lowered to seat on top of the chamber base, the night light bulb, socket and spring clip are hidden from view.

Locking sleeve 209 comprises a shaft 209A with a check-ring 209B fixed to a top end of said shaft and a threaded end 209C comprising a set of external threads machined into the lower end of said shaft. Check-ring 209B may be permanently affixed to the top of shaft 209A or it may be affixed by a threaded or alternate type of connection. Tube 202 passes through the center of said sleeve. Threaded coupling 210 comprises an internally threaded cup fixed concentrically in some manner to tube 202. The coupling is shown as a cup fixed to the bottom of tube 202, but it may comprise any type of threaded ring fastened in any manner at any point along the tube or the connecting apparatus without departing from the nature of the invention. Thus, the threaded coupling may be located either within or above the chamber base of said lamp while still providing its inventive utility.

The securing apparatus is designed such that when sleeve 209 is threaded into coupling 210, the distance from the top of chamber base 206 to the underside of check-ring 209B matches the depth of associated chamber cover 205. The length of shaft 209A may be varied to accommodate different depths of associated chamber covers.

To hold the chamber cover in place, said cover is slid down tube 202 until seated on the top of chamber base 206. Then locking sleeve 109 is slid downward along the neck tube, its lower threaded end passing through cover 205, and into threaded coupling 110. As locking sleeve 109 is threaded into coupling 110, the bottom of the check-ring impinges on the top of the chamber cover, holding it in place.

FIG. 3 depicts the lamp of FIG. 2 with chamber cover 205 lowered onto the top of the chamber base 206. The locking sleeve 209 of the securing apparatus, is shown threaded into threaded coupling 210 to hold cover 205 in place.

Using the inventive securing apparatus, it is possible to economically vary the aesthetics of the lamp by changing the design of the chamber cover. If the depth of a new-style cover is not altered during this process, no changes need to be made to the securing apparatus. However, if the depth of the cover is changed during the re-design process, the only other part of the lamp that needs adjustment is the length of locking sleeve 209; its length being selected to accommodate a deeper or shallower depth of cover.

For example, in the embodiment of FIG. 4, the same basic lamp is used with a new chamber cover 205′, which is of greater depth than its counterpart as shown in FIG. 3. To accommodate the change in cover depth, a new locking sleeve 209′ is used to secure the cover in place. No other elements of the lamp (i.e., its base, connecting apparatus, threaded coupling, neck tube or main light socket) need to be modified to make the cover adjustment.

Because many varying and different embodiments may be made within the scope of the inventive concept herein taught, and because many modifications may be made in the embodiments herein detailed in accordance with the descriptive requirements of the law, it is to be understood that the details herein are to be interpreted as illustrative and not in a limiting sense.

What is claimed is:

1. A securing apparatus for holding a chamber cover on a chamber base of a lamp, comprising:
a locking sleeve comprising:
a shaft having at an upper end
a check-ring, and at a lower end
a threaded end; and
a threaded coupling affixed to said lamp designed to accommodate said threaded end.

2. The securing apparatus of claim 1, wherein said threaded coupling may be affixed within a chamber base of said lamp.

3. The securing apparatus of claim 1, wherein said threaded coupling may be affixed above a chamber base of said lamp.

4. The securing apparatus of claim 1, wherein said threaded coupling comprises an internally threaded cup affixed concentrically to a neck tube of said lamp.

5. The securing apparatus of claim 1, wherein said threaded coupling comprises an internally threaded ring affixed concentrically to a neck tube of said lamp.

6. The securing apparatus of claim 1, wherein the length of said shaft is selected based on the depth of said chamber cover.

7. The securing apparatus of claim 6, wherein, as said locking sleeve is threaded into said threaded coupling, a bottom edge of said check-ring impinges on a top side of said chamber cover, holding said chamber cover in place.

8. The securing apparatus of claim 1, wherein said check-ring is permanently affixed to said top end of said shaft.
